(19) United States
(12) Patent Application Publication
(10) Pub. No.: US 2021/0002829 A1
(43) Pub. Date: Jan. 7, 2021

(54) ROLLED ABSORBENT PAPER PRODUCTS AND METHODS FOR MAKING SAME

(71) Applicant: The Procter & Gamble Company, Cincinnati, OH (US)

(72) Inventors: Gustav André MELLIN, Amberly Village, OH (US); Steven James SCHROECK, Cincinnati, OH (US)

(21) Appl. No.: 16/915,034

(22) Filed: Jun. 29, 2020

Related U.S. Application Data
(60) Provisional application No. 62/869,136, filed on Jul. 1, 2019.

(51) Int. Cl. D21H 27/00; D21H 25/04; D21H 11/04; B32B 29/06; B32B 29/00; B65H 18/28; A47K 10/16

(52) U.S. Cl. CPC D21H 27/002; D21H 25/04; D21H 11/04; A47K 10/16; B32B 29/005; B65H 18/28; B32B 29/06

(57) ABSTRACT

Rolled absorbent paper products and methods for making are provided. The rolled paper products comprise a hollow cylindrically shaped tube having a visible indicia of bleached cellulose fibers on the tube and a length of an absorbent paper product wound upon the tube. Methods for making the tube employing a laser to bleach cellulose fibers is also provided.

### FIELD OF THE INVENTION

The present disclosure generally relates to rolled absorbent paper products and in particular rolled sanitary tissue products and to methods for making them.

### BACKGROUND OF THE INVENTION

Rolled absorbent paper products such a toilet tissue and towel products are typically wound onto a cylindrical tube or roll core manufactured from a Kraft paper or paperboard material such as cardboard of various thicknesses. The use of non-coated, non-bleached Kraft paper or paperboard products as roll cores has been an industry standard for decades.

At the same time, the placement of visual indicia on the roll core has achieved industry acceptance as the need for tracking or tracing individual rolls for quality control purposes has become a mainstay of the manufacturing process. Sometimes, referred to as core codes, these indicia allow producers of rolled paper products to identify the place, date and time of the rolls manufacture. This identification may provide enhanced speed and knowledge when tracking individual rolls through a manufacturing and distribution chain and for addressing quality concerns or consumer complaints.

The visual indicia are typically applied to the roll core during the core formation process via the use of printing techniques such as ink-jet or flexographic printing. Traditional printing techniques however have several significant disadvantages including frequent maintenance requiring the need for expensive backup systems as well as more frequent line stoppage, and importantly the use of organic inks and solvents. Products substantially free of organic inks and solvents provide a beneficial environmental impact.

In addition, due to the constraints of traditional printing techniques combined with the speed of roll core manufacturing, the visual indicia is applied in a linear pattern onto a high speed moving substrate. The substrate is then helically wound around a mandrel and secured via adhesive to form a cylindrical tube. The combination of the linear printing onto a flat substrate followed by the helical winding results in the visual indicia being positioned or located on the inside of the roll core and in a helical orientation far inside the tube. This helical orientation makes it difficult to read and thereby limits the type and usefulness of the visual indicia.

Accordingly, what is needed is improved rolls of paper products and methods for manufacturing that overcome at least some of the aforementioned shortcomings in the art.

### SUMMARY OF THE INVENTION

In accordance with one aspect of the present disclosure, there has now been provided improved rolled paper products and methods for their manufacture in which visible indicia formed from bleached cellulose fibers are provided on the inside of a roll core. These visible indicia may be substantially parallel to the end of the roll core making them more visible and flexible than currently accepted technology. Thus, the present invention provides a rolled paper product that comprises a hollow cylindrically shaped tube comprising cellulose fibers. The cylindrical tube extends for a length from a first circular end edge to a second circular end edge and comprises an inner radial surface and an outer circumferential surface. A visible indicia defined by bleached cellulose fibers is present on the inner radial surface and may be substantially parallel with the first circular end edge. A length of absorbent paper product, such as consumer tissue or towel, is wound onto the tube.

In accordance with another aspect of the present invention, the tube comprises an inner diameter, Di, and the visible indicia is positioned at a distance, Dm, or less from the first circular end edge, wherein the ratio of Dm to Di is 0.6 or less, or alternatively, the inner diameter, Di, is from about 35 mm to about 55 mm and the visible indicia is positioned at a distance Dm of 25 mm or less from the first circular end edge.

In accordance with yet another aspect of the present invention, a method for making a rolled absorbent paper product is provided. The method comprises advancing a substrate in a machine direction where the substrate comprises cellulose fibers. The substrate further comprises a first surface and an opposing second surface, and a first longitudinal edge and a second opposing longitudinal edge separated from the first longitudinal edge along a cross direction. Energy from a laser is directed onto the first surface of the advancing substrate where the laser energy bleaches the cellulose fibers to form a visible indicia on the first surface of the substrate. The visible indicia is oriented at an angle Φ with respect to the machine direction. After forming the visible indicia, the substrate is helically wound to form a tube where the first surface of the substrate defines an inner radial surface of the tube and the second surface of the substrate defines an outer circumferential surface of the tube.

The second surface proximate to the first longitudinal edge is bonded to the first surface approximate the second opposing longitudinal edge and the first and second longitudinal edges extend along a helix angle being substantially equal to the angle Φ. Finally, a length of paper is wound onto the formed tube to create a finished rolled paper product.

### BRIEF DESCRIPTION OF THE DRAWINGS

The following detailed description of specific embodiments of the present invention shall be read in conjunction with the drawings enclosed herewith.

FIG. 1 is a simplified perspective view of a rolled absorbent paper product.

FIG. 2 is a simplified perspective view of the tube or core of the present invention.

FIG. 3 is a simplified perspective view of the process of the present invention.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION OF THE INVENTION

The description is to be construed as exemplary only and does not describe every possible embodiment since describing every possible embodiment would be impractical, if not impossible. And it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this disclosure, which would still fall within the scope of the claims. All publications and patents cited herein are incorporated herein by reference.

It should also be understood that, unless a term is expressly defined in this specification using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112.

“Absorbent paper product” as used herein means a soft, relatively low density fibrous structure useful as a wiping implement for post-urinary and post-bowel movement cleaning (toilet tissue), for otorhinolaryngological discharges (facial tissue), multi-functional absorbent and cleaning uses (paper towels, shops towels) and wipes, such as wet and dry wipes. The absorbent paper product is convolutely wound upon itself about a tube or core to form a product roll. The absorbent paper product can be single-ply or multi-ply. Such product rolls may comprise a plurality of connected, but perforated sheets of fibrous structure, that are separably dispensable from adjacent sheets.

“Fibrous structure” as used herein means a structure that comprises a plurality of pulp fibers. Pulp fibers are lignocellulosic fibers prepared by mechanically or chemically separating cellulose fibers from wood, fiber crops, recycled waste paper, or the like. In one example, the fibrous structure may comprise a plurality of wood pulp fibers. In another example, the fibrous structure may comprise a plurality of non-wood pulp fibers, for example plant fibers, synthetic staple fibers, and mixtures thereof. In still another example, in addition to pulp fibers, the fibrous structure may comprise a plurality of filaments, such as polymeric filaments, for example thermoplastic filaments such as polyolefin filaments (i.e., polypropylene filaments) and/or hydroxyl polymer filaments, for example polyvinyl alcohol filaments and/or polysaccharide filaments such as starch filaments. Non-limiting examples of fibrous structures of the present invention include paper (including but not limited to absorbent paper products) and paperboard

Non-limiting examples of processes for making fibrous structures include known wet-laid papermaking processes, for example conventional wet-pressed papermaking processes and through-air-dried papermaking processes, and air-laid papermaking processes. Such processes typically include steps of preparing a fiber composition in the form of a suspension in a medium, either wet, more specifically aqueous medium, or dry, more specifically gaseous, in other words with air as the medium. The aqueous medium used for wet-laid processes is oftentimes referred to as a fiber slurry. The fibrous slurry is then used to deposit a plurality of fibers onto a forming wire, fabric, or belt such that an embryonic fibrous structure is formed, after which drying and/or bonding the fibers together results in a fibrous structure. Further processing the fibrous structure may be carried out such that a finished fibrous structure is formed. For example, in some papermaking processes, the finished fibrous structure is the fibrous structure that is wound on the reel at the end of papermaking, often referred to as a parent roll, and may subsequently be converted into a finished product, e.g. a single- or multi-ply sanitary tissue product.

“Machine Direction” or “MD” as used herein means the direction of the flow of a product through the product making machine and/or manufacturing equipment (such as reorientation or stacking equipment).

“Cross Machine Direction” or “CD” means the direction perpendicular to the machine direction.

“Reverse Machine Direction” or “RMD” means the direction parallel to and opposite of the machine direction.

The present disclosure provides rolled absorbent paper products which have visible indicia provided on the central tube or core in which the visible indicia is defined by bleached cellulose fibers rather than the conventional printing techniques of the prior art. The cellulose fibers in the central tube or core are bleached via the application of laser energy upon the fibers during the manufacture of the core or tube. The visible indicia can range from a series of letters, numbers or symbols or may be machine readable code.

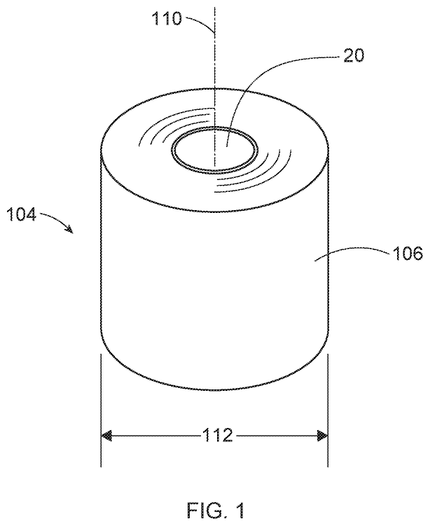

Turning now to FIG. 1, the absorbent paper product 104 may be configured as rolled paper product 106, rolled product, rolls of product, and/or rolls. “Rolled products” or “rolled paper products” or “rolls of product” or “rolls” within the present disclosure may include products made from fibrous structures as set forth above including cellulose fibers. In some configurations, rolled products can be made of, or partially made of recycled fibers. With continued reference to FIG. 1, each roll of product 106 is wound about a paper, cardboard, paperboard, or corrugate tube to form a core 20 through each roll 106. Each core 108 may define a longitudinal axis 110 extending there through.

It is to be appreciated that rolled paper products 106 herein may be provided in various different sizes, and may comprise various different roll diameters 112. For example, in some configurations, the roll diameter 112 of the rolled paper product 106 may be from about 4 inches to about 8 inches, specifically reciting all 0.5-inch increments within the above-recited ranges and all ranges formed therein or thereby. In some configurations, the roll diameter 112 of the rolled paper product 106 may be from about 6 inches to about 14 inches, specifically reciting all 0.5-inch increments within the above-recited ranges and all ranges formed therein or thereby.

Rolled paper products 106 are often packaged in containers for final sale. The containers that house the absorbent paper product may be formed from various types of material and may be configured in various shapes and sizes. In some configurations, the containers may be formed from a poly film material that may comprise polymeric films, polypropylene films, and/or polyethylene films. In some configurations, the containers may be formed from cellulose, such as for example, in the form of paper and/or cardboard. The container may have a preformed shape into which absorbent paper products 104 are inserted and/or may be formed by wrapping a material around one or more absorbent paper products 104 to define a shape that conforms with the shapes of individual products and/or arrangements of products. It is to be appreciated that the packages may include various quantities of absorbent paper products 104 that may be arranged in various orientations within the containers.

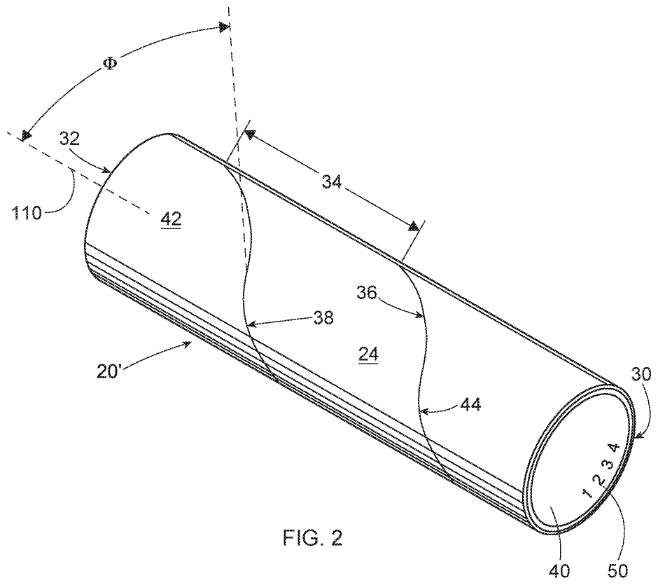

Turning now to FIG. 2, a core 20 of a hollow cylindrical shaped tube is provided. The core is formed from a fibrous structure such as paper, cardboard, corrugate or paperboard having any suitable combination of cellulosic fibers such as hardwoods, softwoods and recycled fibers and may be selected from non-coated or non-dyed paper, cardboard, corrugate or paperboard. For the sake of the present invention, non-coated or non-dyed refers to the lack of a material, layer, or chemical alteration added during manufacture that significantly alters or changes the base color of the fibrous structure. Examples of the foregoing include multilayer substrates in which the top layer provides a color layer, substrates which have been dyed or printed on outer surface or the like.

In addition, the core 20 may exhibit uniform strength without weak spots. The core 20 may have a thickness of at least about 0.4 mm but is less than 2 mm or has a thickness of at least about 0.6 mm. The core may be free of objectionable odors, impurities or other contaminants that may cause irritation to the skin. The fibrous structure of core 20 may be comprised of cellulosic fibers having a recognizable lignin content which for the purposes of the present invention is defined as a fibrous structure having at least about 0.5% lignin, or at least about 1% lignin, or at least about 5% lignin or at least about 10% lignin.

The core 20 may be made of a paperboard having a basis weight of about 25 to about 60 pounds per 1000 square feet and or from about 42 to about 56 pounds per 1000 square feet or from about 50 to about 52 pounds per 1000 square feet.

Core 20 may be formed from a single ply of fibrous material or multiple plies for added strength. Returning to FIG. 2, the core 20 may be formed from a single ply 24. The hollow cylindrical shaped tube is formed by helically or spirally winding ply 24. As used herein, helical winding includes volute and spiral arrangements as well. Ply 24 may be wound at a core wind angle Φ where the angle Φ ranges from about 31 to about 45 degrees and or about 42 degrees relative to a central longitudinal axis 110 although it is to be appreciated that another core wind angle may be employed. In addition, the core has an inner diameter, Di, which typically ranges from about 35 to about 55 mm for consumer type products but one of ordinary skill in the art will appreciate that diameters outside this range are within the scope of the present invention.

Core 20 extends for a finite length between a first circular end edge 30 and an opposed second circular end edge 32 and has an inner radial surface 40 and an outer circumferential surface 42. The inner radial surface 40 is oriented towards a central longitudinal axis of core 20 while outer circumferential surface 42 is oriented away from the longitudinal axis of core 20 and contacts the absorbent paper product when it is wound around the core 20. It should be appreciated that the finite length will vary based on the type of product and the intended final use.

Ply 24 has a width 34 as defined by a first longitudinal edge 36 and a second opposing longitudinal edge 38. First longitudinal edge 36 and second opposing longitudinal edge 38 overlap upon helical winding to form the solid cylindrical tube of core 20 and are adhered to one another using an adhesive such as a starch-based dextrin adhesive although other suitable adhesives may be substituted.

Core 20 includes visible indicia 50 on the inner radial surface 40 or the outer circumferential surface 42. The visible indicia 50 is defined by bleached cellulose fibers of the fibrous substrate. Lignin is a complex polymer that exists in the cell walls of cellulose fibers. Fibrous substrates having a recognizable lignin content such as those in the present invention have a darker or generally brownish color than white or bleached white paper. While not wishing to be bound by theory, it is believed that the application of laser energy as described herein provides a bleaching effect upon the lignin in the cellulose fibers. Thus, visible indicia 50 being defined by bleached fibers can provide visible indicia 50 with a lighter color than the surrounding area making it highly visible and noticeable to consumers.

This lighter color can be defined by CIE76 color by measuring the L, a, b values of the visible indicia and the surrounding area. A comparison of the two numbers via the equation:

Delta E=\sqrt{(L*₂−L*₁)²+(a*₂−a*₁)²+(b*₂−b*₁)²}

provides a Delta E or the change in visual perception between the visual indicia 50 and the non-bleached surrounding area. The Delta E of the visible indicia 50 of the present invention and the non-bleached surrounding areas have a Delta E of at least about 5 or at least about 10 or at least about 11. In addition, the L value in the CIE 76 color can define the relative lightness of a color with L=0 representing the darkest black and L=100 representing the brightest white. L values for the visible indicia 50 may be greater than 65, or greater than 68 or greater than 70.

The visible indicia 50 may be arranged at various angles relative to the first circular end edge 30. As previously stated, due to the constraints of traditional printing techniques combined with the speed of roll core manufacturing, the visual indicia of the prior art is typically applied in a linear pattern onto a high speed moving substrate. The combination of linear printing onto a flat substrate followed by the helical winding, results in the visual indicia in a non-linear relationship such as in a helical pattern on core 20. This helical pattern is often difficult to read and thereby limits the type and usefulness of the visual indicia 50.

With the method of the present invention in which a laser is employed to bleach cellulose fibers, the visible indicia 50 may be applied onto an advancing substrate at a non-linear angle such as an angle similar to the core wind angle Φ. The result is that visible indicia 50 of the present invention may be oriented in a number of different angles and relationships providing much greater flexibility than prior methods. The visible indicia 50 may be applied at a similar angle as the core wind angle Φ such that indicia 50 may be oriented substantially parallel with the first circular end edge 30 of core 20 after the substrate is wound to form the hollow cylindrical core. It should be appreciated that by use of the phrase “similar” and “substantially parallel” that perfection to the identical angle of first circular end edge 30 shall not be required but that visible indicia 50 is intended to largely extend generally in the same direction as first circular end edge 30. The angle between the visible indicia 50 and the first circular end edge 30 may vary between 0 and 20 degrees. It should also be appreciated that in determining the angle of the visible indicia 50, the indicia will be generally considered to be a plane in which the greatest length of the indicia resides and within which it is typically oriented for viewing.

Visible indicia 50 may take the form of alphanumeric characters such as upper and/or lower case letters, numerals, punctuation, symbols, marks and combinations thereof. Visible indicia 50 may be a series of numerals and/or letters commonly employed as an identification code for manufacturing. Visible indicia may also take the form of a graphic, Trademark or Trade name. As used herein, the term “graphic” refers to images or designs that are constituted by a figure (e.g., a line(s)), a symbol or character, a color difference or transition of at least two colors, or the like. A graphic may include an aesthetic image or design that can provide certain benefit(s) when viewed. A graphic may be in the form of a photographic image. A graphic may also be in the form of a 1-dimensional (1-D) or 2-dimensional (2-D) machine-readable code such as a bar code, a quick response (QR) bar code, a Data Matrix code, Snaptag code or the like. A graphic design is determined by, for example, the sizes of the entire graphic (or components of the graphic), the positions of the graphic (or components of the graphic), the geometrical shapes of the graphic (or components of the graphics), the number of graphics printed, or the contents of text messages present in the graphic.

Visible Indicia 50 may be positioned at any distance Dm from first circular end edge 30. However, indicia 50 may be positioned at a distance Dm from first circular end edge 30 to be highly visible to a consumer or other user. Visible indicia 50 may be positioned at a distance Dm such that the ratio of Dm to inner diameter Di is less than 1.0 or less than about 0.6. The visible indicia 50 may be a distance, Dm, of 25 mm or less from the first circular end edge.

Visible indicia 50 may take many different dimensions depending on the end application. When visible indicia 50 takes the form of a manufacturing code, it typically has a width dimension of from about 2 mm to about 7 mm and a length dimension of from about 10 mm to about 50 mm. In addition, given the broad range of available visible indicia that may be employed in the present invention, a large variation in the size of the indicia may occur. According, the visible indicia 50 may comprise from about 0.2% to about 50% of the surface area of the inner radial surface 40. When visible indicia 50 takes the form of a manufacturing code, the indicia 50 may comprise from 0.2% to about 1.5% of the surface area of inner radius 40. In the alternative, when visible indicia 50 takes the form of a graphic, Trademark or Trade Name, the indicia 50 may be from about 10% to about 45% of the surface area of inner radius 40. The surface area for simple visible indicia is determined by multiplying the width of the laser beam times the sum of the path lengths of each character written. For more complex visible indicia, the surface area would be determined by counting the black & white pixels in the graphic image and calculating the % of pixels to be bleached on the core that the graphic contains—and multiplying this percentage by the overall size of the graphic.

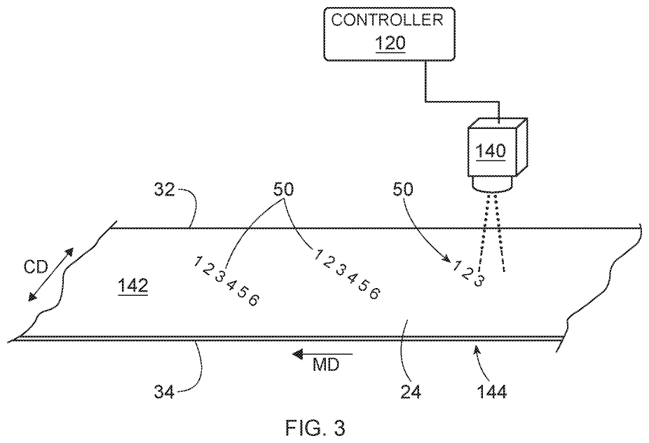

Turning now to FIG. 3 of the present invention, a simplified perspective view of the method of the present invention is provided. A substrate of ply 24 is provided and advanced in a machine direction, MD. Ply 24 having a first surface 142 and an opposing second surface 144 may be advanced in a continuous manner to form a moving web at a linear speed or line speed of from about 0.5 m/s to about 3.0 m/s or about 1.5 to about 2.5 or 2.0 m/s. For continuous operation, ply 24 may be provided from a roll stock paper feeding system and web speed control system both of which are conventionally known in the art.

Energy from a laser 140 is directed onto the first surface 142 where the visible indicia 50 is formed via bleaching of the cellulose fibers of ply 24. Visible indicia 50 may be oriented at an angle that is substantially similar as core wind angle Φ as set forth herein. In addition, selection of the proper laser and operating conditions is an important aspect of the present invention. Improper laser selection and operation parameters may lead to damage of ply 24 such as burning, scorching, blackening, and the like. Accordingly, laser 140 may be a pulsed laser light source such as a CO₂ laser having a wavelength of from about 9.6 um to about 10.8 um, or from about 10 um to about 10.8 um or about 10.6 um. The laser 140 may be operated in a power range of from about 10,000 W/mm2 to about 30,000 W/mm2 or a power range of 20,000 W/mm2 to about 28,000 W/mm2. With the combination of these parameters on the moving web as set forth herein, an exposure time of the laser in any one location of ply 24 may be from about 5 to about 25 microseconds.

Laser 140 may be controllable in relation to first surface 142 or alternatively laser 140 is held static in one location while the energy or beam of the laser is deflected for movement in relation to first surface 142. Deflection of the laser energy may occur via the use of a single or multiple controllable mirror (not shown) according to input from controller 120. Mirror systems for directing laser energy and that allow for control of the orientation of the mirrors via an inputted signal are widely known and conventionally available.

Controller 120 may be a programmable logic controller, a programmable computer or the like as is common in the field. Controller 120 may be adapted to receive an input signal from various sensors that may be present such as a line speed sensor, a readable registration mark, from a computer or other digitally programmable device or from manual entry from an operator. Controller 120 provides outputted signal to laser 140 and any controllable mirrors, when present, to control the selection, orientation, location, synchronization to line speed of visible indicia 50 and the like.

Following application of the indicia 50, the ply 24 is formed into a tube via winding around a waxed mandrel (not shown), which may be any suitable mandrel such as a rod or spindle and is of appropriate diameter to be substantially equal to the desired inside diameter of core 20. The mandrel can be stationary or rotated by any rotary drive means such as a motor or belt (not shown). In one example embodiment, a drive belt can wrap around and frictionally engage a portion of the ply 24 on the mandrel and can be driven to turn and wind ply 24 into a continuous fibrous core. Alternatively, it is believed that the belt could rotate the mandrel as well, or the mandrel could be independently driven and frictionally engage ply 24, thus both the mandrel and ply 24 can rotate to form a core 20.

The ply 24 is wound in a helical fashion according to core wind angle Φ as described herein such that inner surface 142 forms inner radial surface 40 and second surface 144 forms outer circumferential surface 42 as shown in FIG. 2. During the winding of ply 24, the first longitudinal edge 38 overlaps opposing second longitudinal edge 38 to create a seam 44. The overlapped portion of ply 24 of the first and second longitudinal edges 36, 38, extends along a helix angle being substantially equal to the core wind angle Φ. The overlap width of first and second longitudinal edges 36 and 38 forming seam 44 may be variable as needed to determine the strength of seam 44 or may vary from about 0.5 mm to about 50 mm, or from about 5 mm to about 8 mm.

An adhesive may be disposed on ply 24 prior to being wound about the mandrel. The adhesive may be disposed on either side or both sides of ply 24 in the overlap portion of first and second longitudinal edges 36 and 38 which creates seam 44. The adhesive may be applied in amount sufficient to bind ply 24 in the overlap portion once it is wound about the mandrel. More specifically, the adhesive can be applied on about 20% to 100% of the overlap portion. For example, the adhesive can be applied on about 20% of the overlap portion to bind the first longitudinal edge 36 to the second longitudinal edge 38. The adhesive can be a liquid or solid when applied to ply 24. In one embodiment, the adhesive can be in the form a solid strip, such as double-sided tape or heat activated adhesive strips. One or more solid strips of adhesive can be present across the overlap portion. For example, in one embodiment, the heat activated adhesive strip that is not activated can be disposed on ply 24 prior to winding and later be activated by a heat source to aid in winding of ply 24. In another embodiment, the adhesive can be in the form of a liquid, such as Adhesin Tack 6N74 available from Henkel or PA 3501 EN available from H.B. Fuller. The liquid adhesive can be slot extruded on to ply 24 in an amount sufficient to bind the first and second longitudinal edges 36 and 38 in the overlap portion. In another embodiment, the liquid adhesive can be sprayed onto ply 24 in an amount sufficient to bind the first and second longitudinal edges 36 and 38 in the overlap portion. In yet another example embodiment, the adhesive can be applied using a gravure roll or anilox roll.

After adhesive application and winding, the overlap portion is bonded to create seam 44 by the use of pressure, such as a belt, a pressure foot or roller (not shown) pressing against the paper and mandrel during the core winding process. The pressure is applied to ply 24 in the area substantially equal to the overlap portion. Pressure is applied which is sufficient to compress the first and second longitudinal edges 36 and 38 to form seam 44.

In the optional continuous operation, upon winding the continuous formed tube is passed to a cut off station where the continuous formed tube is cut to an appropriate length to form a core tube. The cutting section typically employs a cam or servo operated saw or knife as is conventionally known in the art. The cut core tube is than conveyed to a finishing or winding section and a length of an absorbent paper product is wound upon the core tube as is also conventionally known in the art. Processes to produce core tubes are disclosed in U.S. Pat. Nos. 9,505,179 and 9,561,929, the disclosure of which is herein incorporated by reference.

### Delta E Measurement Method

The Delta E Measurement Method is used to measure the magnitude of color difference between the interior of a laser-etched region on a sample, such as a single letter character or numerical digit, and its surroundings. A flatbed scanner capable of scanning a minimum of 24-bit color at 2400 dpi with manual control of color management (a suitable scanner is an Epson Perfection V750 Pro from Epson America Inc., Long Beach Calif., or equivalent) is used to acquire images. The scanner is interfaced with a computer running color calibration software capable of calibrating the scanner against a color reflection IT8 target utilizing a corresponding reference file compliant with ANSI method IT8.7/2-1993 (suitable color calibration software is Monaco EZColor or i1Studio available from X-Rite Grand Rapids, Mich., or equivalent). The color calibration software constructs an International Color Consortium (ICC) color profile for the scanner, which is used to color correct an output image using an image analysis program that supports application of ICC profiles (a suitable program is Photoshop available from Adobe Systems Inc., San Jose, Calif., or equivalent). The color corrected image is then converted to into the CIE L*a*b* color space for subsequent color analysis (a suitable image color analysis software is MATLAB available from The Mathworks, Inc., Natick, Mass.).

The samples are conditioned at about 23° C.±2 C.° and about 50%±2% relative humidity for 2 hours prior to testing.

The scanner is turned on 30 minutes prior to calibration and image acquisition. Deselect any automatic color correction or color management options that may be included in the scanner software. If the automatic color management cannot be disabled, the scanner is not appropriate for this application. The recommended procedures of the color calibration software are followed to create and export an ICC color profile for the scanner. The color calibration software compares an acquired IT8 target image to a corresponding reference file to create and export the ICC color profile for a scanner, which will be applied within the image analysis program to correct the color of subsequent output images.

The scanner lid is opened and the sample carefully laid flat on the center of the scanner glass with the laser-etched region oriented toward the glass. A 1 inch by 1 inch (25.4 mm by 25.4 mm) scan containing a laser etched region is acquired and imported into the image analysis software at 24 bit color with a resolution of 2400 dpi (approximately 94.5 pixels per mm) in reflectance mode. The ICC color profile is assigned to the image producing a color corrected sRGB image. This calibrated image is saved in an uncompressed format to retain the calibrated R,G,B color values, such as a TIFF file, prior to analysis.

The sRGB color calibrated image is opened in the color analysis software, and converted into the CIE L*a*b* color space. This is accomplished by the following procedure. First, the sRGB data is scaled into a range of [0, 1] by dividing each of the values by 255. Then the companded sRGB channels (denoted with upper case (R,G,B), or generically V) are linearized (denoted with lower case (r,g,b), or generically v) as the following operation is performed on all three channels (R, G, and B):

$$V ∈ \{ R , G , B \}$$

$$v ∈ \{ r , g , b \}$$

$$v = \{ \begin{matrix}\frac{V}{12.92} if V \leq 0.04045 \\ {( \frac{V + 0.055}{1.055} )}^{2.4} otherwise\end{matrix} \}$$

The linear r, g, and b values are then multiplied by a matrix to obtain the XYZ Tristimulus values according to the following formula:

$$[ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 09505\end{matrix} ] [ \begin{matrix}r \\ g \\ b\end{matrix} ]$$

The XYZ Tristimulus values are rescaled by multiplying the values by 100, and then converted into CIE 1976 L*a*b* values as defined in CIE 15:2004 section 8.2.1.1 using D65 reference white.

The CIE L*a*b* image is analyzed by cropping out a rectangular area containing a single distinct laser etched region, such as a single letter character or numerical digit, from the image for analysis. The rectangular area should be small enough to contain a single distinct laser etched region, but large enough to also contain a representative amount of non-etched area immediately surrounding it for color comparison. A region of interest (ROI) boundary is manually drawn around the visibly discernable perimeter of the etched region, such that the ROI interior only contains etched material. The average L*, a*, and b* values within the ROI are measured and identified as L*₁, a*₁, and b*₁. The average L*, a*, and b* values are then measured for the remaining non-etched portion of the rectangular region surrounding the etched region ROI, and identified as L*₂, a*₂, and b*₂. The Delta E value is then calculated according to the following equation:

Delta E=\sqrt{(L*₂−L*₁)²+(a*₂−a*₁)²+(b*₂−b*₁)²}

This procedure is repeated on ten (10) replicate images of substantially similar laser etched regions. The arithmetic mean of the ten replicate Delta E values is calculated and reported as the Delta E value to the nearest 0.1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A rolled absorbent paper product comprising:
a hollow, cylindrically shaped tube comprising cellulose fibers, the tube extending for a length from a first circular end edge to a second circular end edge, the tube comprising an inner radial surface and an outer circumferential surface;
a visible indicia defined by bleached cellulose fibers on the inner radial surface, the visible indicia being substantially parallel with the first circular end edge; and
a length of an absorbent paper product wound onto the tube.

2. The rolled absorbent paper product of claim 1, wherein the tube comprises an inner diameter, Di, and the visible indicia is positioned at a distance, Dm, or less from the first circular end edge, wherein the ratio of Dm to Di is 0.6 or less.

3. The rolled absorbent paper product of claim 2, wherein inner diameter, Di is from about 35 mm to about 55 mm and the visible indicia is positioned at a distance, Dm, of 25 mm or less from the first circular end edge.

4. The rolled absorbent paper product of claim 1, wherein the visible indicia has a width dimension of from about 2 mm to about 7 mm.

5. The rolled absorbent paper product of claim 1, wherein the visible indicia has a length dimension of from about 10 mm to about 50 mm.

6. The rolled absorbent paper product of claim 1, wherein cellulose fibers on the inner radial surface have been removed to a depth of from 5 microns to 25 microns.

7. The rolled absorbent paper product of claim 1, wherein the inner radial surface has a surface area and from 0.2% to about 50% of said surface area has bleached fibers.

8. The rolled absorbent paper product of claim 7, wherein from 0.2% to about 1.5% of the inner radial surface has bleached fibers.

9. The rolled absorbent paper product of claim 1, wherein the outer circumferential surface has a visible indicia defined by bleached cellulose fibers.

10. The rolled absorbent paper product of claim 1 wherein the visible indicia has a color difference, Delta E, vs. a non-bleached area of the inner radial surface of greater than 5.

11. The rolled absorbent paper product of claim 1 wherein the visible indicia has a color difference, Delta E, vs. a non-bleached fiber containing area of the inner radial surface of greater than 10.

12. A method for making a rolled absorbent paper product, the method comprising:
advancing a substrate in a machine direction, the substrate comprising cellulose fibers, the substrate further comprising a first surface and an opposing second surface, and a first longitudinal edge and a second opposing longitudinal edge separated from the first longitudinal edge along a cross direction;
directing energy from a laser onto the first surface of the advancing substrate;
the laser energy bleaching the cellulose fibers to form a visible indicia on the first surface of the substrate, wherein the indicia is oriented at an angle Φ with respect to the machine direction;
helically winding the substrate to form a tube wherein the first surface of the substrate defines an inner radial surface of the tube and the second surface of the substrate defines an outer circumferential surface of the tube;
bonding the second surface proximate to the first longitudinal edge and the first surface approximate the second opposing longitudinal edge, and wherein the first and second longitudinal edges extend along a helix angle being substantially equal to the angle Φ; and
winding a length of absorbent paper product onto the tube.

13. The method of claim 12, further comprising cutting the tube into individual lengths such that the tube has a first circular end edge and a second circular end edge, and the visible indicia is substantially parallel with the first circular end edge.

14. The method of claim 13, wherein the core comprises an inner diameter Di and the visible indicia is positioned at a maximum distance Dm or less from the first circular end edge, wherein the ratio of Dm to Di is 0.6 or less

15. The method of claim 12, where the laser comprises a CO2 laser at a wavelength of from about 9.6 um to about 10.8 um.

16. The method of claim 12, wherein the angle Φ ranges from about 31 to about 45.

17. The method of claim 12, wherein the substrate comprises a non-coated and non-dyed Kraft paper or paperboard.

18. The method of claim 17, wherein the advancing substrate moves at a linear speed of from about 0.5 m/s to about 3.0 m/s.

19. The method of claim 12, wherein the laser energy is applied at a power density of from about 10,000 W/mm2 to about 30,000 W/mm2.

20. A rolled absorbent paper product comprising:
a hollow, cylindrically shaped tube comprising a substrate of cellulose fibers;
the substrate comprising a non-coated and non-dyed Kraft paper or paperboard and extending for a length from a first circular end edge to a second circular end edge, the tube comprising an inner radial surface and an outer circumferential surface;
a visible indicia defined by bleached cellulose fibers on the inner radial surface of the tube;
the visible indicia having a color difference, Delta E, vs. a non-bleached fiber containing area of the inner radial surface of greater than 5; and
a length of an absorbent paper product wound onto the tube.
